(19) United States
(12) Patent Application Publication
(10) Pub. No.: US 2026/0363269 A1
(43) Pub. Date: Nov. 19, 2026

(54) FROZEN AERATED CONFECTION

(71) Applicant: MAGNUM ICC US, LLC, Wilmington, DE (US)

(72) Inventors: Julian Francis BENT, Wageningen (NL); Liam Peter David RATCLIFFE, Wageningen (NL); Peter Conrad SCHUETZ, Wageningen (NL)

(21) Appl. No.: 19/477,485

(22) PCT Filed: Apr. 18, 2024
(86) PCT No.: PCT/EP2024/060577

§ 371 Date: Oct. 22, 2025

(30) Foreign Application Priority Data
Apr. 24, 2023 (EP) 23169611.3

(51) Int. Cl. A23G 9/46; A23G 9/04; A23G 9/32; A23G 9/34; A23G 9/38; A23G 9/42; C11C 3/10

(52) U.S. Cl. CPC A23G 9/46; A23G 9/04; A23G 9/327; A23G 9/34; A23G 9/38; A23G 9/42; C11C 3/10

(57) ABSTRACT

A frozen aerated confection comprising a fat component in an amount of 1 wt % to 15 wt %, wherein the fat component comprises interesterified fat, and from 0.1 wt % to 5 wt % of the fat component comprises triglycerides which have from 59 to 63 total carbon atoms and comprise at least one saturated fatty acid having from 20 to 24 carbon atoms; from 95 wt % to 99.9 wt % of the fat component is a composition comprising liquid oil; wherein the fat component comprises triglycerides with 57 carbon atoms (C57) and triglycerides with 61 carbon atoms (C61) in a ratio (C57:C61) of from 10:1 to 30:1.

### FIELD OF THE INVENTION

The present invention relates to frozen aerated confection products, such as ice cream, that are low in saturated fat and have good microstructural properties.

### BACKGROUND OF THE INVENTION

Frozen aerated confections (such as ice creams) are popular foodstuffs. Fat is an important constituent of such confections, as it provides essential structural properties to the product as well as contributing to desirable mouthfeel on eating. Historically, saturated fats have been preferred for such products due to their high melting points, which provides a good microstructure during aeration and ensures the confections are mostly solid during freezing. Popular examples of such fats include dairy fat, palm oil and coconut oil.

There has been a move towards a reduction of the amount of saturated fat in frozen confection products, mainly driven by a desire to improve the health profile of such products. This has mainly involved the replacement of saturated fats with mono- or polyunsaturated fats. For example, US 2008/0220141 A1 discloses a frozen confection, wherein a fat blend is provided that comprises greater than 20% and less than 35% polyunsaturated fat, and less than 65% saturated fat. However, mono- or polyunsaturated fats have lower melting points than saturated fats, and are often liquid at room temperature. Therefore, simply replacing saturated fats with mono- or polyunsaturated fats is not practical, as it results in unacceptable microstructure and can impede aeration.

US 2008/0206425 S1 discloses an ice cream comprising palm oil with a fat content of no more than 55% saturated fat. Preferably, the amount of saturated fat is greater than 30%. However, concern around certain social and environmental impacts of the widescale cultivation of palm oil have led to a move away from its use, and it tends to be considered an undesirable ingredient.

U.S. Pat. No. 6,582,748 discloses a fat composition comprising a vegetable oil and a plant-derived wax ester, together with food and cosmetic products containing such fat compositions. No particular frozen confection embodiments are disclosed. Some of the fat compositions include a blend of the oil and wax, and others include an interesterified oil and wax component. Interesterification generally reduced the solid fat content of the fat compositions in comparison to the equivalent blend (at temperatures of 21.1 °C to 40 °C).

Nasirullah et al. (Int. J. Food Sci. 2010 45:1395-1402) discloses that interesterification of certain coconut oil/vegetable oil blends produces interesterified fats that are liquid and flowable at 6 °C with a solidification temperature between −2.0 °C and −5.5 °C. The interesterified fats have a lower melting point in comparison to the equivalent (uninteresterified) fat blends.

In order to provide frozen aerated confections that are low in saturated fat and have good structural properties, further improvements are desirable.

### SUMMARY OF THE INVENTION

In a first aspect, the invention relates to a frozen aerated confection comprising a fat component in an amount of 1 wt % to 15 wt %, wherein the fat component comprises interesterified fat, and
from 0.1 wt % to 5 wt % of the fat component comprises triglycerides which have from 59 to 63 total carbon atoms and comprise at least one saturated fatty acid having from 20 to 24 carbon atoms;
from 95 wt % to 99.9 wt % of the fat component is a composition comprising liquid oil;
   wherein the fat component comprises triglycerides with 57 carbon atoms (C57) and triglycerides with 61 carbon atoms (C61) in a ratio (C57:C61) of from 10:1 to 30:1.

In a second aspect, the invention relates to a process for the preparation of the frozen aerated confection of the first aspect, wherein the process comprises preparing a fat component by:
(a) providing a blend of liquid oil and wax ester; and then
(b) preparing the fat component by interesterification of the blend of liquid oil and wax ester.

### DETAILED DESCRIPTION OF THE INVENTION

Unless defined otherwise, all technical and scientific terms used herein have the same meaning as commonly understood by one of ordinary skill in the art (e.g. in frozen confection formulation and manufacture). Definitions and descriptions of various terms and techniques used in frozen confectionery manufacture are found in “Ice Cream” (7th Edition, 2013) by Goff & Hartel (ISBN 978-1-4614-6095-4).

The present invention relates to a frozen aerated confection. Frozen confection means a confection made by freezing a pasteurised mix of ingredients such as water, fat, sugars, protein, and optionally other ingredients such as emulsifiers, stabilisers, colours and flavours. Frozen confections include ice cream, frozen yoghurt, and the like. Preferably the frozen confection is an ice cream. Although the terms “ice cream” and “frozen yoghurt” suggest the presence dairy ingredients, in the context of the present invention a confection comprising no dairy ingredients may still be described as an ice cream or frozen yoghurt.

As used herein, the term “aerated frozen confection” refers to a frozen confection where a gas has been intentionally incorporated into the product. The gas is preferably air, although any food-grade gas can be used. The amount of gas incorporated in the product is conveniently described by overrun (with unit “%”), which is defined by the following equation:

$$overrun = \frac{volume of aerated product - volume of initial mix}{volume of initial mix} \times 100 \%$$

Overrun is measured at ambient temperature (20 °C) and atmospheric pressure. If the overrun is too low, the aerated frozen confection tends to be “sloppy” on extrusion and does not hold its shape. Preferably the aerated frozen confection has an overrun of at least 75%, more preferably at least 80%. Preferably the aerated frozen confection has an overrun of no more than 140%, more preferably no more than 130%.

The frozen aerated confection comprises a fat component in an amount of 1 wt % to 15 wt %, preferably in an amount of from 2 wt % to 10 wt %. The fat component comprises interesterified fat. Fats are largely made up of triglycerides (approximately 98%), together with minor amounts of other components such as phospholipids and diglycerides. Triglycerides are esters of glycerol with three fatty acids. Interesterification is a process that rearranges the fatty acids of a triglyceride by breaking and reforming the ester bonds (C—O—C) that connect the fatty acid chains to the glycerol moiety.

Fatty acids which have no carbon-carbon double bonds are said to be saturated (SAFA), whereas fatty acids that contain one carbon-carbon double bond are said to be monounsaturated (MUFA) and those with multiple carbon-carbon double bonds are referred to as polyunsaturated (PUFA). SAFA, MUFA and PUFA contents of fats and oils are given in “The Lipid Handbook” (3rd Edition, 2007) by Gunstone, Harwood & Dijkstra (ISBN 978-0-8493-9688-5).

Interesterification can be used to adjust the physical characteristics of fats (such as melting point, solid fat content, and crystallization behaviour). In contrast to hydrogenation, interesterification generally preserves the original distribution of fatty acids in the product. Therefore, interesterification of fats is expected to preserve the nutritional and health attributes associated with the starting materials (e.g. reduced SAFA content).

From 0.1 wt % to 5 wt % of the fat component comprises triglycerides which have from 59 to 63 total carbon atoms and comprise at least one saturated fatty acid having from 20 to 24 carbon atoms. Preferably from 0.5 wt % to 5 wt %, or even from 1 wt % to 5 wt % of the fat component comprises triglycerides which have from 59 to 63 total carbon atoms and comprise at least one saturated fatty acid having from 20 to 24 carbon atoms. Triglycerides having from 59 to 63 total carbon atoms means that this is the total number of carbon atoms present in the three fatty acid chains and the glycerol moiety of the triglycerides. Preferably the at least one saturated fatty acid having from 20 to 24 carbon atoms has 20 carbon atoms, 22 carbon atoms, or 24 carbon atoms. Preferably the at least one saturated fatty acid having from 20 to 24 carbon atoms is selected from the group consisting of arachidic acid, behenic acid, and lignoceric acid.

Preferably from 0.1 wt % to 5 wt %, from 0.5 wt % to 5 wt %, or even from 1 wt % to 5 wt % of the fat component consists of triglycerides which have from 59 to 63 total carbon atoms and at least one saturated fatty acid having from 20 to 24 carbon atoms. More preferably from 0.1 wt % to 5 wt %, from 0.5 wt % to 5 wt %, or even from 1 wt % to 5 wt % of the fat component consists of triglycerides which have from 59 to 63 total carbon atoms and at least one saturated fatty acid selected from the group consisting of arachidic acid, behenic acid and lignoceric acid.

Preferably, the triglycerides which have from 59 to 63 total carbon atoms comprise one fatty acid having from 20 to 24 carbon atoms, and two fatty acids having from 16 to 18 carbon atoms. Preferably, the triglycerides which have from 59 to 63 total carbon atoms comprise one fatty acid selected from the group consisting of arachidic acid, behenic acid and lignoceric acid, and two fatty acids having from 16 to 18 carbon atoms. The fatty acids comprising from 16 to 18 carbon atoms may be saturated or unsaturated. For example, these fatty acids may correspond to the fatty acids naturally present in rice bran oil or high oleic sunflower oil. The fatty acids comprising from 16 to 18 carbon atoms are preferably selected form the group consisting of C16:0, C16:1, C18:0, C18:1 and C18:2. Preferably, the triglycerides which have from 59 to 63 total carbon atoms comprise two fatty acids having from 16 to 18 carbon atoms and selected from the group consisting of C16:0, C16:1, C18:0, C18:1, and C18:2. The fatty acid notation of: C16:0, C16:1, C18:0, C18:1 and C18:2 means the number of carbon atoms and unsaturated double bonds per fatty acid. C16:0, C16:1, C18:0, C18:1 and C18:2 include palmitic acid, palmitoleic acid, stearic acid, oleic acid, and linoleic acid.

From 95 wt % to 99.9 wt % of the fat component is a composition comprising liquid oil. Liquid oil means an oil that is liquid at 25 °C. Preferably from 95 wt % to 99.5 wt %, or even from 95 wt % to 99 wt % of the fat component is a composition comprising liquid oil. The liquid oil may be obtained from any suitable food-grade source. The liquid oil is preferably selected from the group consisting of rice bran oil, high oleic sunflower oil, and mixtures thereof. Rice bran oil and high oleic sunflower oil comprise high levels of monounsaturated fatty acids, and low levels of saturated fatty acids (e.g. in comparison with coconut oil, which is often used as the fat component in frozen confections). Preferably the composition comprising liquid oil comprises rice bran oil in an amount of at least 20 wt %, at least 30 wt %, or even at least 40 wt %. Additionally or alternatively the composition comprising liquid oil preferably comprises high oleic sunflower oil in an amount of at least 20 wt %, at least 30 wt %, or even at least 40 wt %.

The composition comprising liquid oil may additionally comprise free fatty acids, fatty acid esters, and wax esters. Where the composition comprising liquid oil additionally comprises a wax ester, the wax ester is preferably selected from the group consisting of rice bran wax, sunflower wax, and mixtures thereof. Where the composition comprising oil additionally comprises free fatty acid and fatty acid esters, these will typically be C16:1, C18:0, C18:1, and C18:2 fatty acids and esters thereof, including palmitic acid, palmitoleic acid, stearic acid, oleic acid, and linoleic acid, and esters of palmitic acid, palmitoleic acid, stearic acid, oleic acid, and linoleic acid. The fatty acid esters will typically be the methoxy esters of the fatty acid.

Preferably the composition comprising liquid oil comprises the liquid oil in an amount of at least 50 wt %, at least 70 wt %, or even at least 90 wt %. The composition comprising liquid oil may comprise up to 100 wt % liquid oil, i.e. where the composition comprising liquid oil does not comprise any free fatty acids, free fatty acid esters, and wax esters. In a preferred embodiment, the composition comprising liquid oil comprises free fatty acids in an amount of 0 wt % to 20 wt %, free fatty acid esters in an amount of 0 wt % to 20 wt %, and wax esters in an amount of from 0 wt % to 4.9 wt %.

The fat component comprises triglycerides with 57 carbon atoms (C57) and triglycerides with 61 carbon atoms (C61) in a ratio (C57:C61) of from 10:1 to 30:1. In other words, the triglycerides of the fat component have a C57:C61 ratio of from 10:1 to 30:1. Preferably, the triglycerides of the fat component have a C57:C61 ratio of from 15:1 to 28:1, more preferably from 20:1 to 25:1.

The frozen aerated confection typically comprises from 1 wt % to 10 wt % protein, or even from 2 wt % to 8 wt % protein. Protein may originate from a dairy or non-dairy source. Examples of proteins are described on pages 60 to 65 of “Ice Cream” (7th Edition, 2013) by Goff & Hartel (ISBN 978-1-4614-6095-4).

The frozen aerated confection typically comprises at most 30 wt % of total sugars. Sugars include mono- and disaccharides (such as sucrose, fructose, glucose and lactose). The total sugar content of the frozen confection is the sum of all of the digestible mono- and di-saccharides present in the frozen confection. The frozen confection preferably comprises at most 30 wt %, at most 28 wt %, at most 26 wt %, or even at most 24 wt % total sugars. The frozen confection preferably comprises at least 5 wt %, at least 10 wt %, or even at least 15 wt % total sugars.

Frozen confections according to the present invention preferably comprise at least one emulsifier. Emulsifiers provide beneficial structuring properties, allowing greater control of the physical properties of the frozen confection. Examples of emulsifiers, together with their characteristics are described on pages 82 to 84 of “Ice Cream” (7th Edition, 2013) by Goff & Hartel (ISBN 978-1-4614-6095-4). Emulsifiers are typically mono- and di-glycerides (E471), polysorbate 80 (E433), or egg yolk. The frozen aerated confection preferably comprises from 0.01 wt % to 0.6 wt % emulsifier, from 0.05 wt % to 0.5 wt % emulsifier, or even from 0.1 wt % to 0.4 wt % emulsifier.

The frozen confection may additionally comprise stabilizer. Examples of stabilizers, together with their characteristics are described on pages 75 to 82 of “Ice Cream” (7th Edition, 2013) by Goff & Hartel (ISBN 978-1-4614-6095-4). Suitable stabilizers include one or more of tara gum, guar gum, locust been gum, carrageenan, gelatin, alginate, carboxymethyl cellulose, xanthan, and pectin. The frozen aerated confection preferably comprises from 0.01 wt % to 0.6 wt % stabilizer, from 0.05 wt % to 0.5 wt % stabilizer, or even from 0.1 wt % to 0.4 wt % stabilizer.

The frozen aerated confection preferably comprises 20 wt % to 60 wt % total solids, more preferably 25 wt % to 50 wt %, or even 30 wt % to 45 wt %. Total solids is the sum of all of the ingredients other than water. A method for measuring total solids is set out on page 406 of “Ice Cream” (7th Edition, 2013) by Goff & Hartel (ISBN 978-1-4614-6095-4).

In a preferred embodiment, the frozen aerated confection comprises the fat component in an amount of 1 wt to 15 wt %, protein in an amount of 1 wt % to 10 wt %, sugars in an amount of 10 wt % to 30 wt %, emulsifier in an amount of 0.05 wt % to 0.5 wt %, and stabilizer in an amount of 0.05 wt % to 0.5 wt %.

In a second aspect, the invention relates to a process for the preparation of the frozen aerated confection of the first aspect, wherein the process comprises preparing a fat component by:
(a) providing a blend of liquid oil and wax ester; and then
(b) preparing the fat component by interesterification of the blend of liquid oil and wax ester.

The process comprises the step of interesterification of a blend of triglyceride esters and a wax ester, wherein the fatty acids on the triglyceride are interchanged with the fatty acids of the wax ester.

It has been found that a fat component that is prepared by interesterification between triglyceride fats and a wax ester can result in an increase in solid fat content of the fat component (measured at −20 °C) compared to a corresponding blend of the liquid oil and wax ester (i.e. a blend of the unreacted starting materials). The increased solid fat content increases the stability of a frozen confection, enabling an increase in overrun without increasing the saturated fat content and without the waxy mouthfeel sometimes associated with wax esters.

Interesterification involves interchange between the fatty acids of the triglycerides of the liquid oil with the fatty acid of the wax ester. It is therefore preferred that, prior to interesterification, the average length of the fatty acid of the wax ester is greater than the average length the fatty acids of the triglyceride. In particular it is preferred that the average length of the fatty acids of the triglyceride is from 14 to 20. It is also preferred that the average length of the fatty acid of the wax ester is from 20 to 30.

Naturally occurring triglycerides typically comprise fatty acids that are substantially the same length, and differ only slightly to each other. The process of interesterification provides triglycerides that may have a wider range of lengths of fatty acid groups, which is believed to provide the improvements in the physical properties and mouthfeel of the resulting frozen aerated confection.

There are two types of interesterification reactions: chemical interesterification (i.e. performed using a catalyst such as sodium methoxide) and enzymatic interesterification (i.e. where an enzyme, such as a esterase or lipase, is used to break and reform the ester bonds). The process of the present application is preferably a chemical interesterification reaction. It has been found that a relatively high amount of catalyst is desirable in order to ensure that a sufficient degree of interesterification occurs. In particular, it is preferred that the interesterification is carried out using a sodium methoxide catalyst and the sodium methoxide catalyst is present in an amount of at least 0.05% by weight of the blend of liquid oil and wax ester, and more preferably at least 0.1%, at least 0.2%, at least 0.5%, or even at least 1% by weight of the blend of liquid oil and wax ester. It is preferred that sodium methoxide catalyst is present at a level of up to 5%, up to 4%, and most preferably up to 3% by weight of the blend of liquid oil and wax ester.

A wax ester is an ester made up of a long chain fatty acid component and a long chain alcohol component. The result is a hard waxy material that is solid at room temperature. A suitable wax ester comprises a C20 to C36 fatty alcohol chain and a C20 to C26 fatty acid chain. Preferably the wax ester is selected from the group consisting of rice bran wax, sunflower wax, and mixtures thereof.

Prior to interesterification, the blend of liquid oil and wax ester preferably comprises from 1 wt % to 10 wt % of the wax ester. In other words, the blend of liquid oil and wax ester provided step (a) preferably comprises from 1 wt % to 10 wt % of the wax ester. More preferably, the blend of step (a) comprises from 1.5 wt % to 8 wt, or even from 2 wt % to 6 wt % 2 wt % to 7 wt % of the wax ester.

Liquid oil means an oil that is liquid at 25 °C. The liquid oil provides a source of triglycerides for the interesterification reaction. The liquid oil may be obtained from any suitable food-grade source. Preferably the liquid oil is selected from the group consisting of rice bran oil, high oleic sunflower oil, and mixtures thereof.

Rice bran oil and high oleic sunflower oil comprise high levels of monounsaturated fatty acids, and low levels of saturated fatty acids (e.g. in comparison with coconut oil, which is often used as the fat component in frozen confections). The blend of liquid oil and wax ester provided in step (a) preferably comprises rice bran oil in an amount of at least 40 wt %. High oleic sunflower oil is also an excellent source of monounsaturated fatty acids. Additionally or alternatively, the blend of liquid oil and wax ester provided in step (a) preferably comprises high oleic sunflower oil in an amount of at least 40 wt %.

Prior to interesterification, the blend of liquid oil and wax ester preferably comprises from 90 to 99 wt % liquid oil. In other words, the blend of liquid oil and wax ester provided in step (a) preferably comprises from 90 to 99 wt % liquid oil, from 92 wt % to 98.5 wt % liquid oil, or even from 94 wt % to 98 wt % liquid oil. Preferably, prior to the interesterification, less than 40 wt % of the fatty acids are saturated, more preferably less than 30 wt %. Typically, at least 10 wt % of the fatty acids will be saturated.

The main product of the interesterification reaction is the portion of the fat component that comprises the triglycerides which have from 59 to 63 total carbon atoms and comprise at least one saturated fatty acid having from 20 to 24 carbon atoms. In addition, the fat component will likely comprise liquid oil that has not undergone interesterification. It is also possible that the fat component will comprise by-products of the interesterification reaction, for example free fatty acids that are displaced from the triglyceride by the fatty acid originating from the wax ester, or esters of such free fatty acids. Such free fatty acid and fatty acid ester may comprise fatty acids originating from the liquid oil, the wax ester, or both the liquid oil and wax ester. Such free fatty acid and fatty acid ester will typically comprise one or more fatty acids such as palmitic acid, palmitoleic acid, stearic acid, oleic acid and linoleic acid.

The manufacture of frozen aerated confections is well known to the skilled person, and is described in detail in Chapter 4 of “The Science of Ice Cream” (2nd Edition, 2012) by Clarke (ISBN 978-1-84973-127-0). For example, a suitable process comprises the following steps:
(A) combining all ingredients except the fat component with water, and mixing to form an aqueous phase;
(B) adding the fat component to the aqueous phase of step (a), and mixing to form a premix;
(C) homogenization and pasteurization of the premix;
(D) ageing;
(E) freezing and aeration;
(F) extrusion; and
(G) optionally deep freezing.

Unless otherwise specified, numerical ranges expressed in the format “from x to y” are understood to include x and y. In specifying any range of values or amounts, any particular upper value or amount can be associated with any particular lower value or amount.

Except in the examples and comparative experiments, or where otherwise explicitly indicated, all numbers are to be understood as modified by the word “about”. As used herein, the indefinite article “a” or “an” and its corresponding definite article “the” means at least one, or one or more, unless specified otherwise.

### FIGURES

By way of example, the present invention is illustrated with reference to the following figures, in which:

FIG. 1 is the DSC melting curve of the fat components of Examples 2, 3, 6, and 12;

### EXAMPLES

The examples are intended to illustrate the invention and are not intended to limit the invention to those examples per se.

### ABBREVIATIONS

In the examples, the following abbreviations are used:
B=blend;
CNO=coconut oil;
FFA=free fatty acids (20% palmitic acid, 45% oleic acid, 35% linoleic acid);
IE=interesterification;
HOSO=high oleic sunflower oil;
RBO=rice bran oil;
RBW=rice bran wax;
SFW=sunflower wax.

### Examples 1 to 12

The composition of the fat components used in the ice cream formulations of Examples 1 to 12 is shown in Table 1. For the interesterification process, the blend of oil and wax is first dried under high vacuum, then placed under N₂ prior to the addition of NaOMe catalyst (1.5 wt %). The reaction was allowed to proceed under vacuum at 95 °C for 3 hours, and then quenched with aqueous citric acid before being filtered through celite/fullers earth mix to obtain a purified fat component comprising interesterified fat.

TABLE 1
Composition of fat components used in Examples 1 to 12

| Example | CNO | RBO | RBW | HOSO | SFW | FFA |
|---|---|---|---|---|---|---|
| 1 | 100 | — | — | — | — | — |
| 2 (B) | — | 95 | 5 | — | — | — |
| 3 (IE) | — | 95 | 5 | — | — | — |
| 4 (B) | — | 97.5 | 2.5 | — | — | — |
| 5 (IE) | — | 97.5 | 2.5 | — | — | — |
| 6 | — | 100 | — | — | — | — |
| 7 (B) | — | — | — | 95 | 5 | — |
| 8 (IE) | — | — | — | 95 | 5 | — |
| 9 (B) | — | — | — | 97.5 | 2.5 | — |
| 10 (IE) | — | — | — | 97.5 | 2.5 | — |
| 11 | — | — | — | 100 | — | — |
| 12 (B) | — | 80 | — | — | — | 20 |

### Ice Cream Formulations:

| | | |
|---|---|---|
| Fat component | 5 | wt % (see Table 1) |
| Skimmed milk powder | 7 | wt % |
| Sucrose | 20 | wt % |
| Emulsifier | 0.3 | wt % |
| Stabilizer | 0.3 | wt % |
| Water | to 100 | wt % |

Briefly, the ingredients (excluding the fat component) were combined and mixed with heating (60 °C to 75 °C), followed by addition of the fat component and further mixing. The mixes were pasteurised and homogenised, and then aged at 4 °C for at least 1 hour, and preferably overnight.

After the ageing step, the mixes were aerated in a scraped surface heat exchanger (standard ice cream freezer). The air input was controlled to give a target overrun of 100%, and freezing was controlled to give a target extrusion temperature of −3 °C to −5 °C.

### Overrun

The overrun of the ice creams was measured at ambient temperature (20 °C) and atmospheric pressure. Overrun (with unit “%”) was calculated using the following equation:

$$overrun = \frac{volume of aerated product - volume of initial mix}{Volume of initial mix} \times 100 \%$$

TABLE 2
Overrun of Examples 1 to 12

| | Example | | | | | |
|---|---|---|---|---|---|---|
| | 1 | 2 (B) | 3 (IE) | 4 (B) | 5 (IE) | 6 |
| Overrun | 111% | 72% | 129% | 91% | 103% | 72% |
| | Example | | | | | |
| | 7 (B) | 8 (IE) | 9 (B) | 10 (IE) | 11 | 12 (B) |
| Overrun | 58% | 78% | 58% | 80% | 48% | 94% |

Table 2 shows the overrun achieved for Examples 1 to 12. Example 1 (100% CNO) represents a standard fat component used in commercial ice cream samples. Samples where the fat component comprised interesterified fat achieved a higher overrun than samples where the fat component was a blend of the corresponding oil/wax. On the other hand, samples where the fat component was an unblended liquid oil (Examples 6 and 11) tended to achieve a lower overrun that either the blended or interesterified fat component. Higher overrun is an indication of an ice cream having a microstructure with improved stability (in particular with regard to air cell structuring) and desirable organoleptic properties (e.g. small air bubbles result in a smooth texture). In contrast, low overrun ice creams may have undesirable properties, for example they tend to be hard and icy, making them difficult to scoop.

Example 12 (a blend of RBO and FFA) was included to ensure that the improvement in overrun observed was due to interesterified fat, and not due to free fatty acids that might have been produced as byproducts during the interesterification reaction. The ice creams comprising fat components comprising interesterified far (Examples 3 and 5) both had a higher overrun than Example 12. Indeed, the overrun of Example 12 (94%) was very similar to that of Example 4 (91%), in which the fat component was a blend of 97.5% RBO and 2.5% RBW.

### Solid Fat Content of Fat Component

The melting curve of some of the fat components described in Table 1 was measured by Differential Scanning calorimetry (DSC) over a range of temperatures. The samples were enclosed in sealed aluminium pans, melted and then cooled to −80 °C. The samples were held at this temperature for 5 minutes, and then heated to 150 °C at 20 °C/min. Typically, the measurements taken between −40 °C and 80 °C were recorded, since this is the temperature range most relevant to frozen confections and their manufacture.

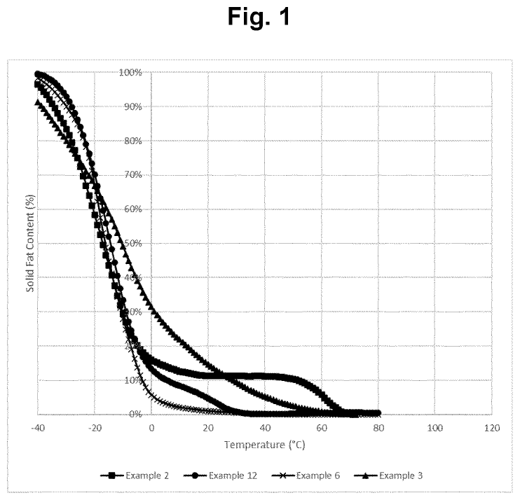

FIG. 1 shows the melting curves of the fat components of Example 2 (RBO/RBW blend), Example 3 (RBO/RBW interesterification), Example 6 (100% RBO), and Example 12 (RBO/FFA blend). It can be seen that between −20 °C and −5 °C, the melting curves of the blends (Example 2, Example 12) and the unblended control (Example 6) all have similar gradients. However, the melting curve of the interesterification sample (Example 3) has a shallower gradient. This indicates that long chain acyl groups form the wax have been incorporated into the triglycerides of the fat component as a result of the interesterification reaction.

### Triglyceride Composition of Fat Component

The fatty acid composition of triglycerides was measured by AOAC Method 996.06, which is a hydrolytic extraction gas chromatographic (GC) method. The fat component was extracted into ether, and then methylated to fatty acid methyl esters (FAME) using boron trifluoride before running through the GC. Since individual FAMEs elute at different times, this method provides a means to separate chains of different length. The results are shown in Table 3.

TABLE 3
Triglyceride composition of fat components

| | Triglyceride composition (%) | | | | | C57:C61 |
|---|---|---|---|---|---|---|
| Example | C55 | C57 | C59 | C61 | C63 | ratio |
| 2 (blend) | 35.8 | 37.4 | 2.6 | 0.9 | 0.6 | 41.6:1 |
| 3 (IE) | 20.3 | 24.0 | 1.9 | 1.1 | 0.8 | 21.8:1 |
| 7 (blend) | 10.8 | 77.4 | 2.0 | 2.0 | 0.5 | 38.7:1 |
| 8 (IE) | 6.6 | 46.9 | 2.7 | 2.0 | 0.4 | 23.5:1 |

Compared to the corresponding blend, interesterification results in an increase in triglycerides with a higher carbon number, and a decrease in triglycerides with a lower carbon number. In particular, the ratio of triglycerides having a carbon number of 57 (C57) to triglycerides having a carbon number of 61 (C61) is significantly different, with interesterification resulting in fewer C57 triglycerides per C61 triglyceride.

1. A frozen aerated confection comprising a fat component in an amount of 1 wt % to 15 wt %, wherein the fat component comprises interesterified fat, and
from 0.1 wt % to 5 wt % of the fat component comprises triglycerides which have from 59 to 63 total carbon atoms and comprise at least one saturated fatty acid having from 20 to 24 carbon atoms;
from 95 wt % to 99.9 wt % of the fat component is a composition comprising oil that is liquid at 25 °C;
wherein the fat component comprises triglycerides with 57 carbon atoms (C57) and triglycerides with 61 carbon atoms (C61) in a ratio (C57:C61) of from 10:1 to 30:1.

2. The frozen aerated confection as claimed in claim 1, wherein the triglycerides which have from 59 to 63 total carbon atoms comprise:
one fatty acid having from 20 to 24 carbon atoms; and
two fatty acids having from 16 to 18 carbon atoms.

3. The frozen aerated confection as claimed in claim 2, wherein the two fatty acids having from 16 to 18 carbon atoms are selected from the group consisting of C16:0, C16:1, C18:0, C18:1, and C18:2.

4. The frozen aerated confection as claimed in claim 1, wherein the oil that is liquid at 25 °C is selected from the group consisting of rice bran oil, high oleic sunflower oil, and mixtures thereof.

5. The frozen aerated confection as claimed in claim 1, wherein the composition comprising liquid oil additionally comprises a wax ester, preferably selected from the group consisting of rice bran wax, sunflower wax, and mixtures thereof.

6. The frozen aerated confection as claimed in claim 1, wherein the fat component has a C57:C61 triglyceride ratio of from 15:1 to 28:1.

7. The frozen aerated confection as claimed in claim 1, wherein the frozen aerated confection comprises protein in an amount of from 1 wt % to 10 wt %.

8. The frozen aerated confection as claimed in claim 1, wherein the frozen aerated confection comprises sugars in an amount of from 5 wt % to 30 wt %.

9. A process for the preparation of a frozen aerated confection as claimed claim 1, wherein the process comprises preparing a fat component by:
(a) providing a blend of liquid oil and wax ester; and then
(b) preparing the fat component by interesterification of the blend of liquid oil and wax ester.

10. The process as claimed in claim 9, wherein the interesterification is carried out using a sodium methoxide catalyst and the sodium methoxide catalyst is present in an amount of at least 1% by weight of the blend of liquid oil and wax ester.

11. The process as claimed in claim 9, wherein the wax ester in the blend of step (a) comprises a C20 to C36 fatty alcohol chain and a C20 to C26 fatty acid chain.

12. The process as claimed in claim 9, wherein the blend of step (a) comprises from 1 wt % to 10 wt % of the wax ester.

13. The process as claimed in claim 9, wherein the blend of step (a) comprises rice bran oil in an amount of at least 40 wt %.

14. The process as claimed in claim 9, wherein the blend of step (a) comprises high oleic sunflower oil in an amount of at least 40 wt %.
